(19) United States
(12) Patent Application Publication
(10) Pub. No.: US 2009/0027517 A1
(43) Pub. Date: Jan. 29, 2009

(54) Method, apparatus, and system for pre-compression assessment of compressed data length

(75) Inventor: Dmitri Jerdev, South Pasadena, CA (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 11/878,606

(22) Filed: Jul. 25, 2007

(51) Int. Cl. H04N 9/73

(52) U.S. Cl. 348/231.6

(57) ABSTRACT

A method and apparatus are disclosed for image processing using dynamic assessment of image line data to select a compression technique for compressing the image line data prior to storage in a line buffer used for an image processing operation. Compressing the image line of data prior to storage in the line buffer permits reduction in the size of the line buffer. The compressed image data may be decompressed prior to the image processing.

### FIELD OF THE INVENTION

Embodiments of the invention relate generally to the field of data compression and storage and, more particularly, to compression and storage of image data for image processing.

### BACKGROUND OF THE DISCLOSURE

Memory requirements can be a significant consideration in designing any data processing device or system. Such consideration is especially important in the design of system-on-chip (SOC) devices, which squeeze most, if not all, circuit functions on a single chip.

System-on-chip cameras, such as but not limited to cell phone cameras for example, typically integrate both image sensor and image processing hardware on the same semiconductor die. Consequently, the image processing hardware of SOC imager devices must be very area-efficient. Many imaging devices use line buffers to store and then simultaneously read out multiple lines of image data for image processing. As these line buffers can consume significant chip space in a SOC imager device, a reduction in the size of the line buffers is desirable.

### BRIEF DESCRIPTION OF THE DRAWINGS

FIG. 1 is a block diagram of an imager device 100 which may employ embodiments of the invention.

FIG. 2 is a block diagram of an image processing circuit 200 which may comprise part of the imager device 100 and employs embodiments of the invention.

FIG. 3A is a block diagram of a line memory 300A which may comprise part of the image processing circuit 200.

FIG. 3B is a block diagram of a line memory 300B which may comprise part of the image processing circuit 200.

FIG. 3C is a block diagram of a line memory 300C which may comprise part of the image processing circuit 200 and which employs embodiments of the invention.

FIG. 4A is a block diagram of a first assessor 310A which may be employed by the line memory 300C and which employs embodiments of the invention.

FIG. 4B is a block diagram of a second assessor 310B which may be employed by the line memory 300C and which employs embodiments of the invention.

FIG. 5 is a block diagram of an imaging system 600 which may employ embodiments of the invention.

### DETAILED DESCRIPTION OF THE DRAWINGS

In the following description, reference is made to the accompanying drawings, which form a part hereof. The description is provided to enable those of ordinary skill in the art to make and use the invention and to set forth several, non-limiting embodiments of the invention. Structural, logical, and procedural changes can be made without departing from the spirit and scope of the invention.

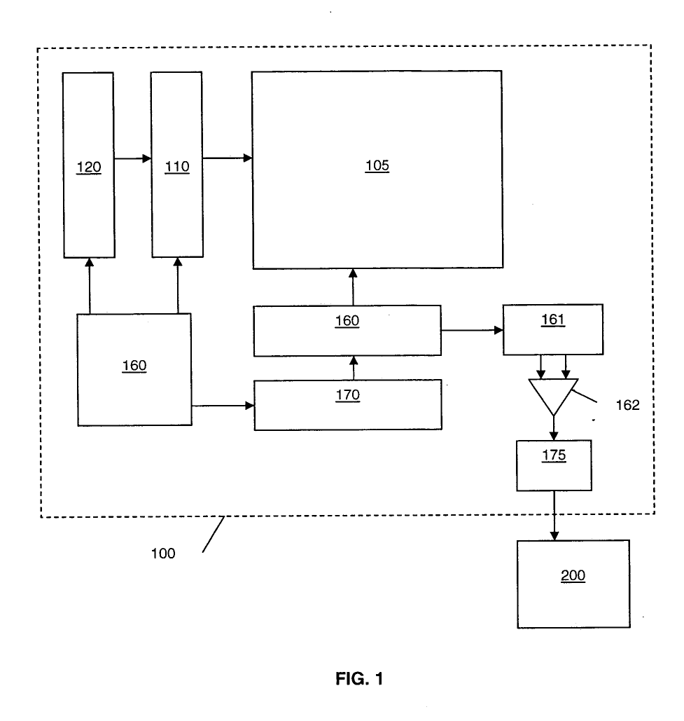

FIG. 1 illustrates a non-limiting example of complementary metal oxide semiconductor (CMOS) imager device 100, which may be implemented as an integrated circuit (IC) forming part of an SOC design. The imager device 100 includes a pixel array 105 containing a plurality of pixel cells arranged in rows and columns. A color filter array and a micro lens array are provided over the pixel array 105, such that each pixel cell outputs a signal associated with at least one particular color. For example, a known Bayer color filter pattern may be used such that pixel cells of array 105 are respectively associated with red, green, or blue colors. The pixel cells of each row in array 105 are all turned on at the same time by a respective row select line, and the pixel cells of each column are selectively output by a respective column line.

The imager device 100 also includes read out circuitry. In particular, the row lines are selectively activated by a row driver 110 in response to a row address decoder 120. The column select lines are selectively activated by a column selector 180 in response to a column address decoder 170. The pixel array 105 is operated by a timing and control circuit 160, which controls the address decoders 120, 170 to select the appropriate row and column lines for image capture and pixel signal read out. The pixel signals, which for a CMOS imager include a pixel reset signal (Vrst) and a pixel image signal (Vsig) for the read out of each pixel cell, are read by one or more sample and hold circuit 161 associated with the column selector 160.

A differential signal (Vrst-Vsig) is produced by differential amplifier 162 for each pixel. The differential signal is amplified and digitized by analog-to-digital converter (ADC) 175 to produce pixel data representing a pixel value for each pixel cell. For example, if the imager device 100 employs 10-bit pixel data, then the differential signal of each pixel cell is digitized to a 10-bit number representing a pixel value of 0 to 1023. Pixel data for one or more image lines is referred to as a line or lines of image data.

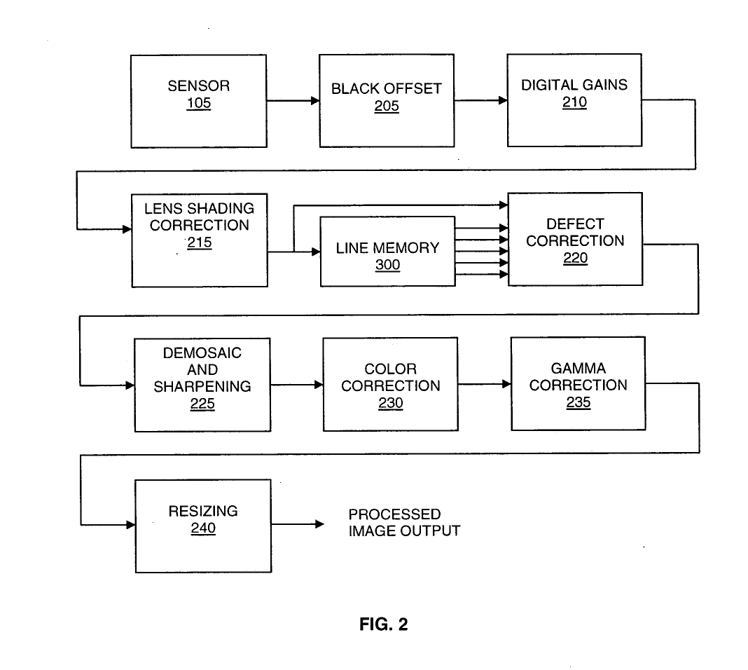

The analog-to-digital converter 175 supplies the pixel data to an image processing circuit 200. FIG. 2 illustrates a non-limiting example of some processing operations which may be performed on image pixel data by the image processing circuit 200. As can be seen, these processing operations may include: black level offset correction 205, digital gain 210, lens shading correction 215, defect correction 220, demosaic and sharpening 225, color correction 230, gamma correction 235, and resizing 240. Some processing operations, such as defect correction, require multiple lines of image data. Thus, lines of image data are sequentially output from the lens shading correction stage 215 to the line memory 300, where the lines of image data are stored to five line buffers (discussed below) and then simultaneously output as a part of a set of six respective lines of image data to the defect correction stage 220. As noted, FIG. 2 is merely an example of image processing operations which may be performed on image data.

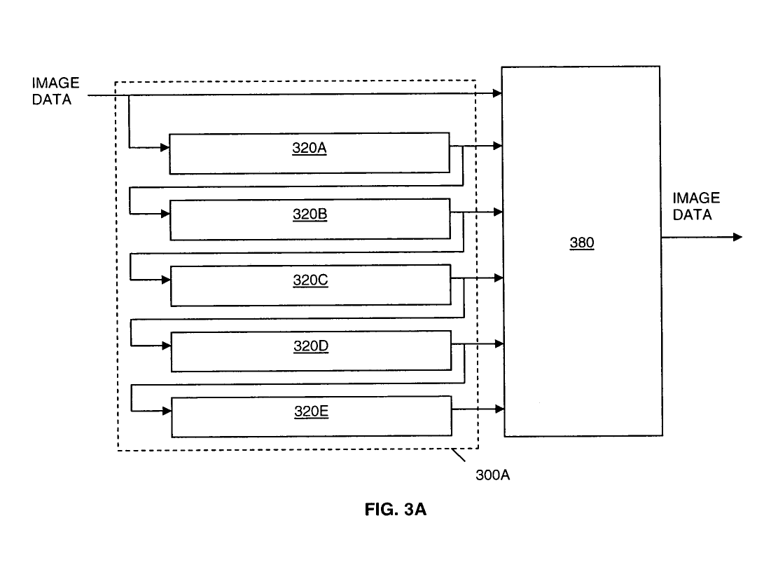

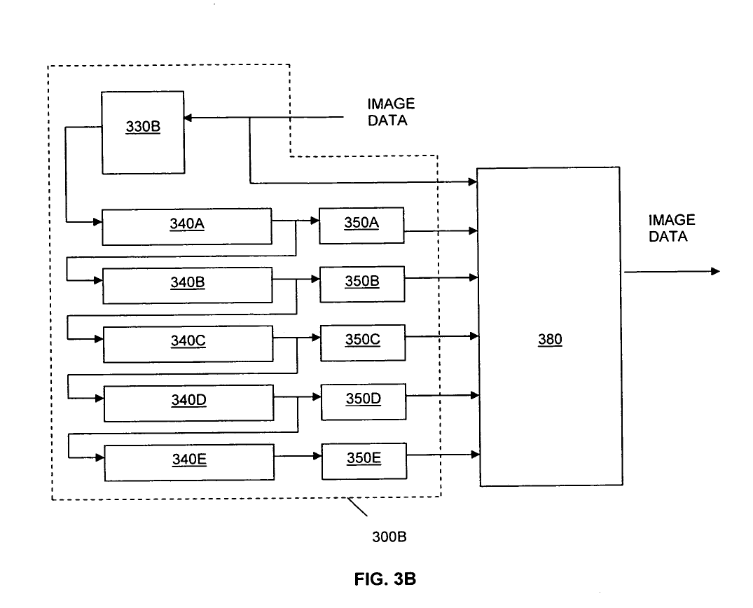

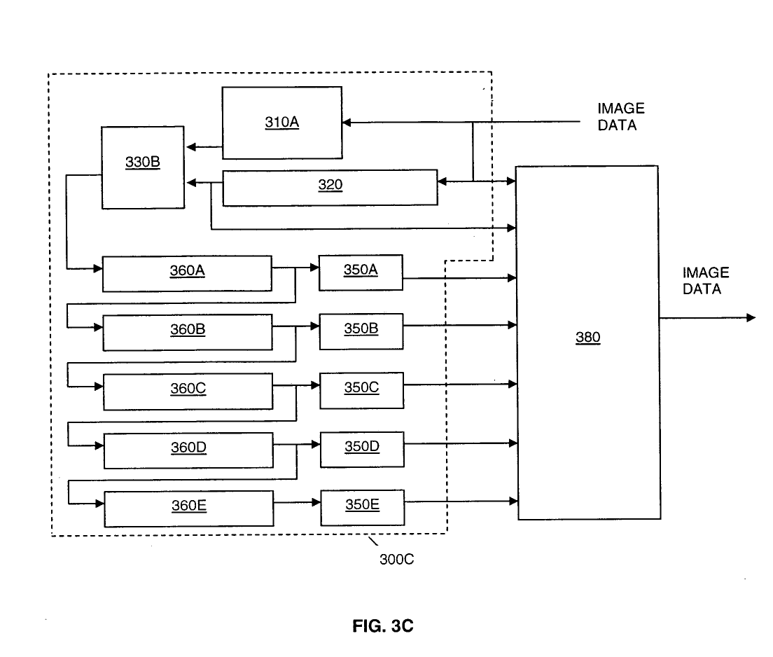

FIG. 3A illustrates a non-limiting example of a line memory 300A which may be employed for line memory 300 of FIG. 2. As shown, individual line buffers 320A-E are serially connected in a first-in-first-out (FIFO) arrangement that queues the incoming lines of image data. Each of the line buffers 320A-E reads out a respective line of image data to the next line buffer (with the exception of the last line buffer 320E). Each of the line buffers 320A-E also reads a respective one of the five stored lines of image data to a processing stage 380 of the image processing circuit 200. In addition, a sixth line of image data is input directly to the processing stage 380. By this configuration, six sequential lines of image data are simultaneously made available to the processing stage 380 for image processing, e.g., lines 1-6 of an image frame (with lines 1-5 respectively read out of the line buffers 320A-E and line 6 input directly to the processing stage 380), then lines 2-7 of the image frame, and so on.

The processing stage 380 of FIG. 3A represents the defect correction processing stage 220 associated with the line memory 300 of FIG. 2, but could be another type of processing stage 380 which requires input from a multiple lines of image data. Further, though in this example six lines of image data are stored and read out by the line memory 300A, this number may be varied in accord with the associated processing operations.

In order to reduce the size of the line buffers 320A-E, related co-pending application Ser. No. ______, filed Jul. 25. 2007, and entitled “Method, Apparatus, and System for Reduction of Line Processing Memory Size Used in Image Processing” (attorney docket no. M4065.1379) discloses a method and apparatus for compressing incoming lines of image data before they are stored to multiple line buffers for image processing. FIG. 3B illustrates a non-limiting example of a line memory 300B corresponding to a compression and storage system described in U.S. Ser. No. ______ (attorney docket no. M4065.1379), which is herein incorporated by reference. Like the line memory 300A, the line memory 300B employs a FIFO arrangement of line buffers 340A-E by which incoming lines of image data are successively stored in the line buffers 340A-E. However, unlike line memory 300A, the line memory 300B employs a compressor 330A to compress an incoming line of image data before storing it to the first line buffer 340A. Accordingly, the line buffers 340A-E of the line memory 300B can be made substantially smaller than the line buffers 320A-E of the line memory 300A, and therefore consume significantly less chip space. The compressed lines of image data are respectively read out of the line buffers 340A-E into respective decompressors 350A-E where the stored image data is decompressed before being processed at image processing stage 380.

The line memory 300B attains a significant reduction in the size of the line buffers 340A-E (as compared to line buffers 320A-E). However, it is possible to achieve a further reduction in line buffer size by making a plurality of different compression techniques available and selecting the best available compression technique for each incoming line of image data. In accordance with embodiments of the invention, the selection is based on an assessment of the lengths of compressed lines of image that would be respectively generated by applying the available compression techniques to the incoming line of image data. Thus, the compression technique applied to one incoming line of image data may be different than the compression technique applied to the next incoming line of image data.

FIG. 3C illustrates in a first embodiment a non-limiting example of a line memory 300C employing such a process of assessment and selection. Like the line memory 300B, the line memory 300C compresses and stores incoming lines of image data in a FIFO arrangement of individual line buffers 360A-E for subsequent image processing. However, unlike the line memory 300B, the line memory 300C selects one of a plurality of available compression techniques to compress an incoming line of image data. As shown, a full line buffer 320 stores the incoming line of image data, such that the uncompressed line of image data is held while the assessor 310 determines which compression technique should be applied.

The selection is performed by an assessor 310A based on calculations of the respective lengths of the compressed lines of image data that would be generated by applying those available compression techniques to the incoming line of image data. For added clarity, these respective lengths are hereinafter referred to as “predicted lengths L” for an incoming line of image data because, as explained below, the predicted lengths L are calculated without actually performing compression. As the name implies, the predicted lengths L need not be precisely determined, but rather may be estimated or approximated by methods known to those skilled in the art.

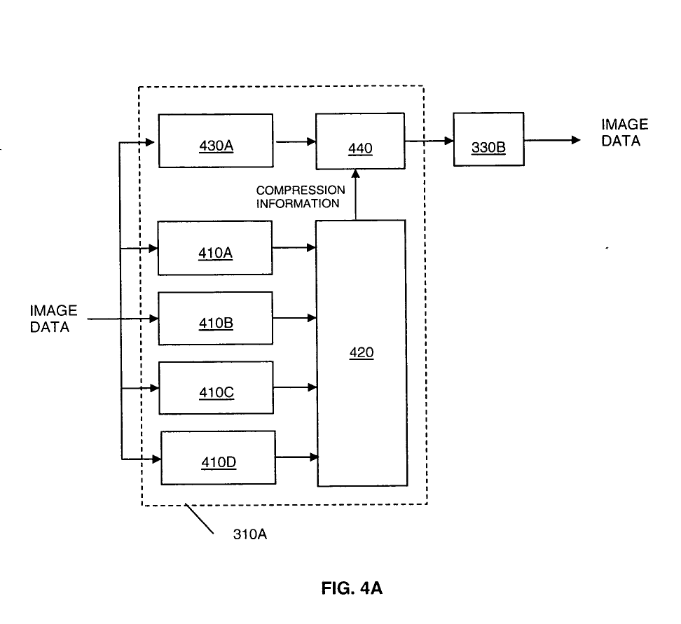

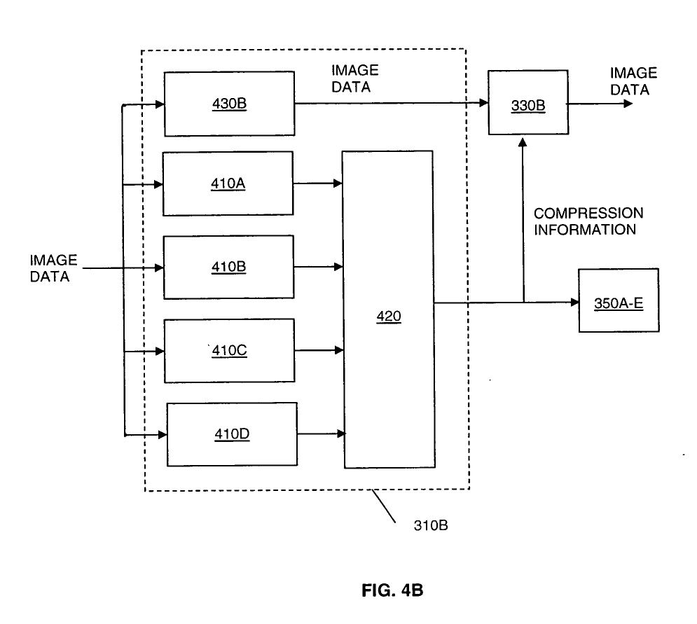

FIGS. 4A and 4B illustrate two different embodiments of an assessor 310A which can be used to select the best available compression technique for compressing the incoming line of image data. The “best available technique” may vary in accord with the particular purposes of the compression. In the following examples, the “best compression technique” is the compression technique that, if applied, would fit the compressed line of image data within the size of the line buffers 360A-E with the least amount of information loss, e.g., with the least amount of variation between the pixel data of the uncompressed and decompressed line of image data. As will be seen, this may be achieved by selecting a compression technique, from among the available compression techniques, that has the greatest predicted length L fitting within the size of line buffers 360A-E, that is by selecting the compression technique which, if applied, would fit the compressed line of image data within the size of the line buffers 360A-E with the least amount of compression. This disclosure sometimes refers to such a selected compression technique as producing a “best fit” between the predicted length L and the size of the line buffers 360A-E.

The assessor 310A may use different criteria to determine which available compression technique should be used by compressor 330B to compress the incoming line of image data. As indicated, one criterion is ensuring that the compressed line of image data will fit within the line buffers 360A-E. Another criterion may be selecting a compression technique that will generate a “best fit” between the size of the compressed line of image data and the size of the line buffers 360A-E. By selecting from one of multiple compression techniques, the assessor 310 increases the maximum amount of compression that can be achieved for each incoming line of image data. By using the “best fit” criterion, the assessor 310A also maximizes the image quality that can be achieved for any particular size of the line buffers 360A-E and nature of incoming data. Accordingly, the assessor 310A provides imager device designers the capability to further reduce the size of the line buffers 360A-E (as compared to the line buffers 340A-E) with less or no sacrifice in image quality.

The assessor 310A provides compression information to the compressor 330B, which uses the compression information to determine and apply the selected compression technique. The lines of image data are compressed by the compressor 330B, stored to the line buffers 360A-E in FIFO order, decompressed by the decompressors 350A-E, and then read out for image processing at processing stage 380. Because each incoming line of image data may be compressed by a different compression technique, the assessor 310A provides respective compression information to each of the decompressors 350A-E. In this example, the assessor 310A distributes the compression information to both the compressor 330B and decompressors 350A-E by appending the compression information to the compressed line of image data, e.g., as header data. Alternatively, however, the compressor 330B may distribute the compression information directly to the compressor 330A and decompressors 350A-E by transmitting a compression information signal. As another alternative, instead of distributing the compression information to the compressor 330B and decompressors 350A-E, the assessor 310A may provide the compression information to a common storage accessible to those components. The distribution of compression information is further explained in the following discussion of assessor 310A, which is described with reference to embodiments shown in FIGS. 4A-B.

Prior to providing examples of the assessor 31A, a brief explanation of lossless and lossy compression is provided below. In lossless compression, all bits of the pixel data are restored to their initial state by decompression. Thus, as implied by the name, no image information is lost. Entropy encoding is an example of lossless compression. In entropy encoding, pixel data are assigned bit representations of varying bit-lengths. More particularly, entropy encoding assigns bit representations having smaller bit lengths to pixel values of greater frequency, and assigns bit representations having longer bit lengths to pixel values of lesser frequency. For example, instead of representing each pixel value with 10-bit pixel data, the most frequently repeated pixel values may be represented with 3-bit pixel data, the next most frequently repeated pixel values represented with 4-bit pixel data, and so on until all pixel values are assigned a new bit representation. Because of the similarity in brightness amongst pixels within a small portion of an image, the same pixel values will be frequently repeated within a line of image data. As the amount of repetition increases, the corresponding compression from entropy encoding increases as well.

The assignments of bit representations are tracked by an entropy encoding table, which is used during decompression to perfectly restore the pixel data of the uncompressed line of image data. A new entropy encoding table may be generated for each compressed line of image data. However, as this may consume a significant amount of processing resources, a preset entropy encoding table may be used to assign the new bit representations. Preset entropy encoding tables do not perfectly assign new bit representations to the pixel values, i.e., they do not perfectly match the bit lengths of the bit representations to the frequencies of the pixel values. Therefore, the selection process of the assessor 310A may involve selecting a compression technique which employs a preset entropy encoding table predicted to generate a “best fit” between the compressed line of image data and the size of line buffers 360A-E.

Unlike lossless compression, lossy compression does not perfectly restore pixel data to its pre-compressed state. Thus, some image information is lost. Quantization is an example of lossy compression. In quantization, pixel data having one value is forced to a different though close pixel value. Related application Ser. No. ______ (attorney docket no. M4065.1379) provides an example of quantization in which 10-bit pixel data representing values 0 to 1023 is scaled by a scaling factor to 8-bit pixel data representing values 0 to 255. In that example, during compression, multiple pixel values of the 10-bit pixel data scale to the same pixel value of the 8-bit pixel data. Consequently, the 10-bit pixel data cannot be perfectly restored during decompression.

Many compression techniques, e.g., JPEG, employ a combination of quantization and subsequent entropy encoding. The quantization is used to increase the frequency of pixel values within a line of image data, which in turn increases the amount of compression resulting from entropy encoding. For example, rounding each pixel value within a line of image data down to the nearest multiple of 2 will make all of the pixel values even and thereby increase the frequency of even pixel values within the line of image data. During entropy encoding, the shortest bit representations can be assigned to the most frequent even pixel values (no odd pixel values remain).

FIG. 4A illustrates a non-limiting embodiment of an assessor 31A. As shown, an incoming line of image data is received by four predictor units 410A-D each respectively corresponding to one of four different compression techniques. The predictor units 410A-D determine the predicted length L, i.e., the length of the compressed line of image data that would result from applying their respective compression technique to the incoming line of image data. In this example, each compression technique applies a particular level of quantization (which can be no quantization) to the pixel data, and then entropy encodes the resulting pixel data by further applying a preset entropy encoding table tailored to that particular level of quantization.

The first predictor unit 410A determines the predicted length L for a compression technique in which no quantization is performed prior to entropy encoding. The second 410B, third 410C, and fourth 410D predictor units respectively determine the predicted length L for a compression technique in which the quantization rounds the pixel values down to a multiple of 2, 4, or 8 prior to entropy encoding. Thus, the second predictor unit 410B corresponds to a compression technique in which the pixel data is rounded down to the nearest even pixel value, and then new bit representations are assigned to the even pixel values. Similarly, the predictor units 410C-D respectively correspond to compression techniques in which the pixel data is rounded down to the nearest multiple of 4 and 8, and then new bit representations are assigned to pixel values that are multiples of 4 and 8.

In this example, as the incoming line of image data is streamed through the predictor units 410A-D, they each determine a predicted length L by summing the bit lengths of all bit representations that would be placed in the compressed line of image data by the respective compression technique. The running total may be calculated via a “counting table” indicating only the bit lengths of the bit representations corresponding to each possible pixel value within the incoming line of image data. If the incoming line of image data has a 10-bit format, then the possible pixel values would be 0 to 1023.

The counting table may be extrapolated from the quantization and entropy encoding operations of the compression technique. For instance, the compression technique of predictor unit 410B entails rounding the pixel data to the nearest multiple of 2 and then entropy encoding the quantized pixel data. If the preset entropy encoding table respectively assigns 2-bit representations of 00, 01, and 11 to the three highest frequency pixel values of 500, 502, and 504, and respectively assigns 3-bit representations of 000, 001, 010, 011, 100, 101, 110, and 111 to the next highest frequency pixel values of 402, 404, 406, 408, 506, 508, 510, and 512, then the counting table would indicate that 2 bits are added to the running total of the predicted length L for each pixel value of 500-505 within the incoming line of image data (because these pixel value are rounded to 500, 502, or 504 by the quantization), and that 3 bits are added to the running total of the predicted length L for each pixel value of 402-409 and 506-513 within the incoming line of image data (because these pixel values are rounded to 402, 404, 406, 408, 506, 508, 5 10, or 512 by the quantization). A counting table may be similarly formulated for each of the predictor units 410B-D.

By using a counting table or the like, each of the predictor units 410A-D can perform a running calculation of the respective predicted length L as the pixel data streams past, e.g., adding 2 bits to the predicted length each time a pixel value of 500-505 streams through predictor unit 410B. The running calculation therefore allows the predictor units 410A-D to determine the predicted length L without storing the entire incoming line of image data. However, the assessor 310A is not limited to storing counting tables or performing running calculations. The above-described use of counting tables is only one example of the manner in which the predicted length L may be determined for the available compression techniques. Other methods should be apparent to those skilled in the art in view of this disclosure.

The predicted lengths L are read out to a selector 420, which compares the predicted lengths L against the size of the line buffers 360A-E. If a predicted length L is less than or equal to the size of the line buffers 360A-E, then the corresponding technique is determined to be a “viable compression technique”, i.e., determined to be a compression technique that would compress the incoming line of image data to a compressed size fitting within the line buffers 360A-E. The selector 420 then selects a viable compression technique, from among the other viable compression techniques, having the greatest predicted length L. The assessor 310A thus ensures that the selected compression technique, as compared to the other available compression techniques, will generate a “best fit” between the size of the compressed line of image data and the size of the line buffers 360A-E.

The selector 420 also reads out compression information, which indicates the selected compression technique, to an appending unit 440 that adds the compression information to the beginning of the incoming line of image data. As some delay is associated with selecting a compression technique, the assessor 310A includes a buffer 430A that correspondingly delays receipt of the incoming line of image data by the appending unit 440. This delay provides the predictor units 410A-D and selector 420 sufficient time to perform their functions and distribute the compression information. In this example, as the compression information indicates only one of four compression techniques, the compression information may be represented by 2 bits of data, namely, 00, 01, 10, or 11, which is appended to the beginning of the incoming line of image data. The compressor 330B may accordingly use the first two bits of each incoming line of image data to determine which one of the four available compression techniques has been selected. The compressor 330B may also leave the 2 bits of compression information appended to the beginning of the compressed line of image data, such that the decompressors 350A-E may also utilize the appended compression information to determine the appropriate decompression technique.

FIG. 4B illustrates a non-limiting example of another assessor 310B, which does not append the compression information to the incoming and compressed lines of image data. Rather, the assessor 310B distributes compression information directly to the compressor 330B and the decompressors 350A-E. In the above example, the compression information can be formed of only 2 bits. However, in instances in which the compression information contains more data, the appending of such compression information to the compressed lines of image data may not be desirable. Furthermore, if the line memory 300C employs a substantial number of individual line buffers 360A-E, then even a small increase in the size of those line buffers 360A-E, to accommodate the appended compression information, may consume a significant of chip space. Accordingly, the assessor 310B of FIG. 4B permits designers to further reduce the size of the line buffers 360A-E by transmitting a compression information signal, which indicates the selected compression technique, to the compressor 330B and decompressors 350A-E. As in the first assessor 31A, the second assessor 310B uses a buffer 430B to delay the incoming line of image data, such that the predictor units 410A-D and selector 420 will have sufficient time to perform their functions and transmit the compression information before the incoming line of image data is received by the compressor 330B.

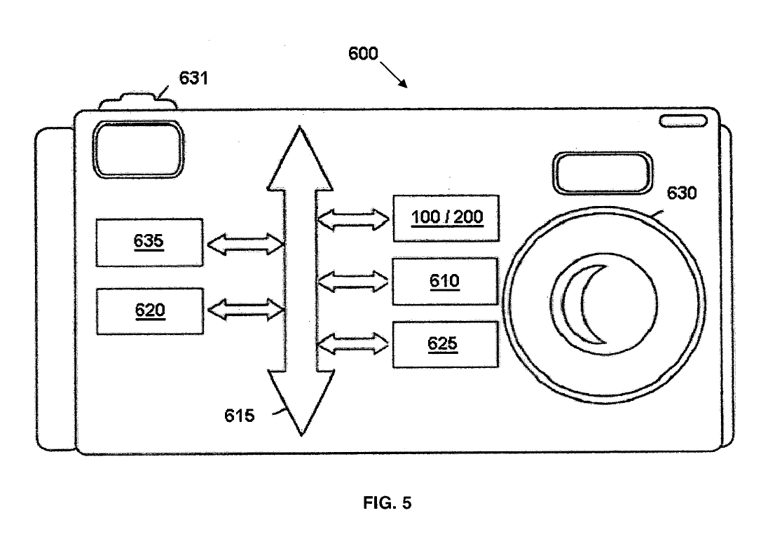

FIG. 5 is a non-limiting example of a processing system 600, e.g., a camera system, which may employ the disclosed embodiments. The processing system 600, which illustrates a still or video camera system, generally comprises a lens 630 for focusing an incoming image on pixel array 105 of an imager 100 to capture an image when a shutter release button 631 is pressed. Also shown is the imager device 100 and associated image processor 200, which may be on the same chip, as in an SOC design, and which may communicate over a bus 615 with one or more input/output (I/O) devices 610 and a CPU 620 for controlling the imager system 600, e.g., camera functions. The system 600 may include random access memory (RAM) 625. Removable memory 635, such as for instance flash memory may also be provided as part of system 600. Although the processing system 680 is illustrated as a camera system, it could be any processing system which acquires and manipulates image data.

The embodiments described herein can be modified to incorporate any number of variations, alterations, substitutions or equivalent arrangements not heretofore described, but which are commensurate with the spirit and scope of the invention. Accordingly, the claimed invention is not limited by the foregoing description or drawings, but is only limited by the scope of the appended claims.

What is claimed as new and desired to be protected by Letters Patent of the United States is:

1. A method of processing image data, comprising:
evaluating a first line of uncompressed image data;
identifying, based on said evaluating of said first line of uncompressed image data, a first compression technique which will compress the first line of uncompressed image data to fit within a line buffer having a bit length less than the bit length of the line of uncompressed image data;
compressing the first line of uncompressed image data using the first compression technique to produce a first line of compressed image data having a first compressed data bit length; and
outputting the first line of compressed image data to the line buffer.

2. The method of claim 1, wherein the step of identifying the first compression technique comprises:
predicting, by examining the line of uncompressed image data, a plurality of compressed data bit lengths that would result from compressing the first line of uncompressed image data in accordance with a respective plurality of compression techniques; and
selecting one of said compression techniques which produces a compressed data bit length fitting within the line buffer as the first compression technique.

3. The method of claim 2, wherein said step of selecting comprises:
determining, based on the predicted plurality of compressed data bit lengths, a plurality of viable compression techniques that would each produce respectively compressed lines of image data fitting within the line buffer;
determining, from among said plurality of viable compression techniques, a single viable compression technique predicted to produce the greatest compressed data bit length; and
selecting said single viable compression technique as said first compression technique.

4. The method of claim 1, further comprising:
sequentially storing the first line of compressed image data into a plurality of FIFO arranged individual line buffers;
reading out the first line of compressed image data from an individual line buffer to a respective decompressor; and
decompressing the first line of compressed image data, read out from the individual line buffer, to produce a first line of decompressed image data.

5. The method of claim 4, further comprising image processing using the decompressed first line of image data.

6. The method of claim 1, further comprising:
compressing, based on a second selected compression technique different than the first compression technique, a second line of uncompressed image data to produce a second line of compressed image data having a second compressed data bit length different than the first compressed data bit length, the first and second lines of uncompressed image data representing respective first and second image lines forming an image.

7. The method of claim 6, further comprising:
storing the first and second lines of compressed image data in FIFO connected line buffers; and
decompressing in parallel the first and second lines of compressed image data stored in the line buffers.

8. The method of claim 6, wherein the first and second compression techniques are lossy compression techniques employing different levels of quantization.

9. The method of claim 6, wherein the first and second compression technique employ different entropy encoding tables.

10. The method of claim 9, wherein the first and second compression techniques are lossless compression techniques.

11. The method of claim 9, wherein one of the first and second compression techniques is a lossless compression technique and the other is a lossy compression technique.

12. The method of claim 9, wherein the first and second compression techniques are lossy compression techniques employing different levels of quantization.

13. The method of claim 1, wherein the steps of compressing and reading out the compressed image data are performed by a pipeline processing circuit.

14. The method of claim 4, wherein the image processing performs at a least one of a lens shading correction, color interpolation, a resize operation, color correction, gamma correction, and color conversion.

15. The method of claim 1, further comprising:
appending compression information data to said first uncompressed line of image data, said compression information data indicating said first compression technique.

16. The method of claim 1, further compressing:
transmitting a compression information signal to a compressor,
wherein said compression information signal indicates the first compression technique and said compressor uses said compression signal to select a compression technique and perform said step of compressing the first line of uncompressed image data.

17. An imager device comprising:
a pixel cell array configured to output pixel signals in lines of image data;
an analog-to-digital converter configured to convert said pixel signals into pixel data; and
a compression and storage system comprising:
a compressor configured to generate a plurality of lines of compressed image data by sequentially compressing, one by one, a respective plurality of lines of uncompressed image data;
a plurality of individual line buffers in a FIFO arrangement configured to sequentially store, one by one, said lines of compressed image data and to read out, simultaneously, each of said stored lines of compressed image data, each of said plurality of line buffers having a bit length less than a bit length of each of said lines of uncompressed image data; and
an assessor configured to identify, based on an evaluation of each of said plurality of lines of uncompressed image data, a respective compression technique which will compress a respective line of uncompressed image data to generate a respective line of compressed image data fitting within each of said plural individual line buffers, and configured to indicate said identified respective compression to said compressor,
said compressor being configured to compress said respective lines of uncompressed image data using a respective identified compression technique to produce lines of compressed image data.

18. The imager device of claim 17, wherein said assessor is further configured to:
predict, by examining a respective line of uncompressed image data, a plurality of compressed data bit lengths that would result from compressing the respective line of uncompressed image data in accordance with a respective plurality of compression techniques; and
select a compression technique for said respective line of uncompressed image data based on said predicted plurality of compressed data bit lengths.

19. The imager device of claim 18, wherein said assessor is further configured to:
determine for said respective line of uncompressed image data, based on the predicted plurality of compressed data bit lengths, a plurality of viable compression techniques that would each produce respectively compressed lines of image data fitting within the individual line buffers;
determine, from among said plurality of viable compression techniques, a single viable compression technique predicted to produce the greatest compressed data bit length; and
select said single viable compression technique as a compression technique for said respective lines of uncompressed image data.

20. The imager device of claim 17, further comprising:
a decompressor configured to decompress the respective lines of compressed image data read out from the plurality of line buffers.

21. The imager device of claim 17, further comprising:
a plurality of decompressors configured to simultaneously receive and decompress said lines of compressed image data from said plurality of line buffers; and
an imaging processing pipeline configured to perform an image line processing operation on said lines of decompressed image data.

22. The imager device of claim 17, wherein said assessor is configured to select different compression techniques for different lines of having a second uncompressed image data.

23. The imager device of claim 22, wherein said the different compression techniques are lossy compression techniques employing different levels of quantization.

24. The imager device of claim 22, wherein said different compression techniques employ different entropy encoding tables.

25. The imager device of claim 24, wherein said different compression techniques are lossless compression techniques.

26. The imager device of claim 24, wherein one of said different compression techniques is a lossless compression technique and the other is a lossy compression technique.

27. The imager device of claim 24, wherein said different compression techniques are lossy compression techniques employing different levels of quantization.

28. The imager device of claim 17, wherein said assessor is configured to append compression information data to said uncompressed lines of image data, said compression information data indicating a compression technique for compressing said uncompressed lines of image data.

29. The imager device of claim 17, wherein said assessor is configured to transmit a compression information signal to a compressor, and said compression information signal identifies a selected compression technique and said compressor uses said compression information signal to perform said step of compressing a line of uncompressed image data.

30. The method of claim 4, further comprising:
storing said first line of uncompressed image data in another line buffer prior to said step of compressing said first line of uncompressed image data;
reading out multiple lines of image data to a processing stage for multiple line processing, said multiple lines of image data including a line of uncompressed image data read out from said another line buffer and lines of decompressed image data read out from respective decompressors of said plurality of FIFO arranged individual line buffers.

31. The imager device of claim 21, further comprising:
another line buffer for sequentially storing and reading out said lines of uncompressed image data to said compressor;
a processing stage for processing multiple lines of image data, said multiples lines of image data including a line of uncompressed image data read out from said another line buffer and said lines of decompressed image data read out from said plurality of decompressors.
